(19) United States
(12) Patent Application Publication
(10) Pub. No.: US 2013/0319960 A1
(43) Pub. Date: Dec. 5, 2013

(54) Low Profile Motorcycle Parking Swing Station Ramp

(71) Applicant: Clayton W. Riihiluoma, Fridley, MN (US)

(72) Inventor: Clayton W. Riihiluoma, Fridley, MN (US)

(21) Appl. No.: 13/483,707

(22) Filed: May 30, 2012

(51) Int. Cl. B62H 3/00

(52) U.S. Cl. 211/21

(57) ABSTRACT

A motorcycle parking swing station having a front wheel support member aligned with and attached to a rear wheel support member with connecting members. A rotatable support plate is located between the bottom of the front wheel support member and the ground and a plurality of axles are attached to the front and rear wheel support members. A plurality of support wheels rotationally attached to the plurality of axles trace a circular path about the center of the rotatable support plate as the motorcycle parking swing station is turned clockwise or counter clockwise.

### BACKGROUND OF THE INVENTION

1. Field of the Invention

The present invention relates generally to a stand for parking a motorcycle in a one car garage and more specifically to a motorcycle swing station ramp which includes a rotatable support plate located between a front wheel support member for the motorcycle and the garage floor which allows a person to rotate the stand about the motorcycle front wheel toward and away from a garage wall.

2. Description of Related Art

When parking a motorcycle in a garage, the prior art consists of either putting a motorcycle on a completely free wheeling tray with the risk of unsafe roll out for the rider, or moving the motorcycle back and forth repeatedly until the motorcycle is next to and parallel with a garage wall. The purpose of being parallel to a garage wall is to provide additional parking space for storage of the motorcycle and a car in essentially a one car stall space. Apparatus for parking a motorcycle is known in the prior art. More specifically, by way of example, U.S. PreGrant Publication No. 2009/0260562 to Folstad; et al. discloses a retractable signaling apparatus and a method of using the apparatus to alert passers-by to the presence of a stationed vehicle that may be obscured from view.

U.S. PreGrant Publication No. 2007/0246284 to Offer discloses a parking device for motor vehicles to facilitate the parallel parking operation when the space available between two parked vehicles is not abundant. The device is mounted on the bottom surface of a motor vehicle and consists of a powered wheel that is lowered to the ground and is pushed down to raise the rear part of a motor vehicle until the rear wheels are no longer in contact with the ground. The lowered wheel, perpendicular to the other wheels of the motor vehicle, is then powered to turn in either directions to cause the rear part of the motor vehicle to move toward the sidewalk until the motor vehicle is parallel to the sidewalk curb and aligned with other parked vehicles.

U.S. PreGrant Publication No. 2003/0215313 to Hinkle discloses a carousel device for pivotally moving a two-wheeled vehicle which includes a base with a plurality of roller bearings and a carousel having a pair of opposing wings which are operatively positioned on the base.

U.S. PreGrant Publication No. 2003/0085546 to Aussant discloses a device for supporting a motorcycle having a planar platform with a top surface for receiving the motorcycle in an upright position. A number of wheels mounted at selected locations of the platform protrude below the platform for support and rolling the platform on a ground surface, such as a concrete floor in a garage. An anchor at the front end of the platform bolts into the ground surface for pivoting the platform over the ground surface. A locking mechanism is provided near the rear end of the platform for selectively engaging the ground surface to keep the platform from pivoting.

U.S. Pat. No. 7,771,155 to Thiel, et al. discloses a multi-lift for lifting and storing motorcycles which includes a column having a vertical threaded shaft. The shaft can rotate in opposite directions through a reversing motor and has a threaded carriage mounted thereon, so that as the shaft rotates in one direction, the vehicle laden carriage may be elevated for storing a vehicle or the reversing motor may be turned in an opposite direction, for lowering a vehicle laden carriage, to provide for unloading.

U.S. Pat. No. 7,474,233 to Ponert discloses a vehicle detection device with a parking gate and a parking stand which includes a geomagnetic field sensor in the parking stand for detecting a vehicle at the parking stand and/or a geomagnetic field sensor in the parking gate for detecting a vehicle beneath the opened parking gate.

U.S. Pat. No. 7,225,900 to Fox discloses a lift for lifting motorcycles which includes a base, an upright extending from the base, a four-bar load-transferring lifting mechanism, a lifting frame adapted to engage the vehicle, and an operator for lifting and lowering the lifting frame.

U.S. Pat. No. 7,150,359 to Lyons, et al. discloses a motorcycle wheel stand having a set of guide rails, a set of vertical supports, a positive stop, and a perpendicular stabilizing tube. The wheel is clamped by pressure supplied by an air spring acting upon a pivoting lever attached to a rotating shoe assembly which rotates up and forward against the rear of the wheel to push the motorcycle into the stand.

### SUMMARY OF THE INVENTION

In an exemplary embodiment of the present invention, there is disclosed a motorcycle parking swing station comprising:
a front wheel support member aligned with and attached to a rear wheel support member with connecting members;
a rotatable support plate located between the bottom of the front wheel support member and the ground;
a plurality of axles attached to the front and rear wheel support members; and
a plurality of support wheels rotationally attached to the plurality of axles;
wherein the wheels trace a circular path about the center of the rotatable support plate.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top perspective view of a motorcycle parking swing station ramp with an on off ramp at the rear of the rear wheel support member in its down position, a stop ramp at the end of a front wheel support member in its up position, and a kick stand receiving plate located on the left side of the ramp in accordance with the principles of the invention;

FIG. 2 is a bottom perspective view of the kick stand receiving plate showing three sets of two wheels where the axel of each set of wheels is set at an angle which allows the wheels to trace a path along an arc the center of which is located at the front wheel support member;

FIG. 3 is a top perspective view of the rear ramp at the end of the rear wheel support member in its down position which automatically prevents the back of the rear support member from moving when in its down position; and

FIG. 4 is a perspective view of the bottom of the front wheel support member showing the rotatable support plate and a set of two wheels rotatably coupled to a common axel and oriented to move along an arc the center of which is located at the front wheel support member.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

The prior art consists of either putting a motorcycle on a completely free wheeling tray or ramp with risk of unsafe roll out for the rider, or moving the motorcycle back and forth repeatedly on the floor of the garage until the motorcycle is next to and parallel with a garage wall.

The purpose of being parallel to a garage wall is to provide additional parking space for storage of a motorcycle and a car in essentially a one car stall space.

The present invention is a low profile storage ramp which is easy to move about a fixed arc, the center of which is located at the front wheel support member of the motorcycle front wheel support member. The rear wheel support member includes an on off ramp which, when in its down position, automatically locks the rear wheels of the rear wheel support member from rotating. In operation, the storage ramp is placed parallel to either a front, side, or back wall of a garage, thus significantly aiding in preserving parking area for an automobile and a motorcycle with one automobile stall space.

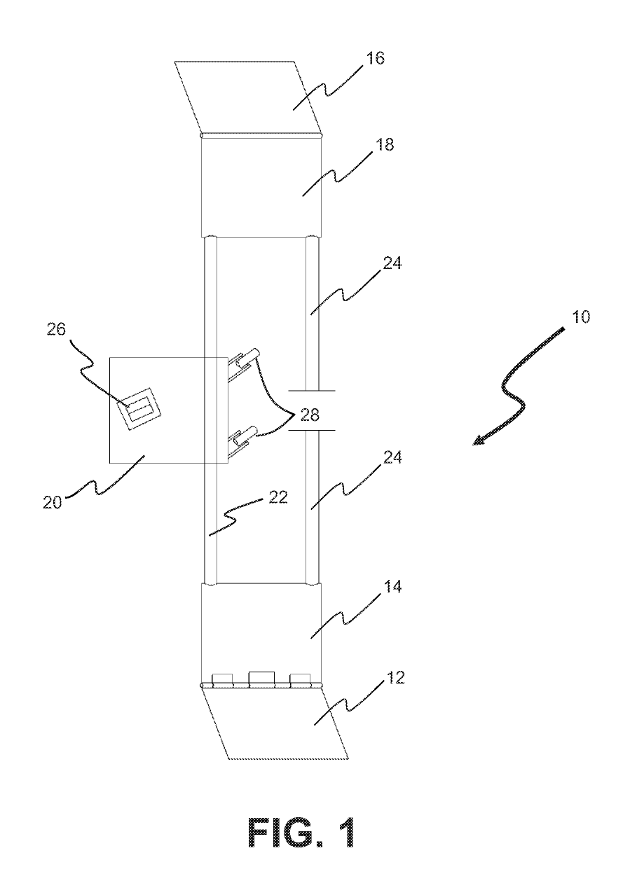

Referring to FIG. 1, there is shown a top perspective view of a motorcycle parking swing station ramp with an on off ramp at the rear of the rear wheel support member in its down position, a stop ramp at the end of a front wheel support member in its up position, and a kick stand receiving plate located on the left side of the ramp in accordance with the principles of the invention

When ready to park a motorcycle, the rider flips up the on off ramp at the rear of the rear wheel support member and effortlessly rotates the rear of the storage ramp clockwise away from the wall to a point of about 45 degrees from the garage wall and toward the front wheel of a motorcycle. A safety locking brake which locks the wheels at the rear of the rear wheel support member is then engaged by having the rider simply step on and lower the rear on off ramp. The rider then rolls or drives the motorcycle over the ramp until the left side kick stand is centered with the kick stand receiving plate. A front wheel on off stop ramp which is located at the end of the front wheel support member aids the rider to automatically center the motorcycle for the proper parking kick stand down position.

The rider then puts down the kick stand and parks the motorcycle on the ramp and disembarks from the motorcycle. The rider then simply walks to the rear of the ramp and with his hand, flips up the ramp which automatically disengages the safety brake lock mechanism which locks the rear wheels from turning. Once the safety brake lock is disengaged, the rider can effortlessly pivot or swing the rear of the motorcycle back into the parallel position to the wall. Once parked to within approximately 16 inches parallel to the garage wall, the rider then with his hand or foot either partially or fully flips the rear ramp to its down position. At this time the rider has an option to push down completely on the rear ramp to lock the motorcycle into the parallel position for long term or more secure anti-swing storage or to partially flip the rear ramp down which will allow the rear of the ramp with the motorcycle to be pulled away from the wall.

To begin a new ride, the rider simply reverses the steps listed above and rolls the motorcycle off the rear of the ramp for use.

A safety feature of the present invention is the soft fixed wheels which aid in the stopping of forward and reverse movement of the ramp while parking the motorcycle. The plurality of support wheels are attached to a plurality of axles which are permanently affixed to the swing ramp and each wheel is oriented to rotate along a path move along a fixed arc, the center of which is located at the front wheel support member of the motorcycle front wheel support member.

The ramp also includes a lazy Suzan type of rotating plate located on the underside of the front wheel support member. The rotating plate is attached to the underside of the front wheel support member with a single bolt and nut and is separated from the front wheel support member with a nylon type slip spacer. The bottom of the rotating plate contacts the floor of the garage. Thus, the rotating plate is located between the front wheel support member and the floor of the garage and allows the front of the ramp to swing easily either clockwise or counter clockwise, even when a heavy motorcycle is located on the ramp.

An additional feature of the invention is that the wheel are oriented to roll along a fixed arc, the center of which is located at the front wheel support member of the motorcycle front wheel support member. The weight of the motorcycle in conjunction with the wheels which are oriented to roll along a fixed arc, the center of which is located at the front wheel support member of the motorcycle front wheel support member aids in the prevention of forward and backward movement of the ramp when rolling the motorcycle on or off the ramp.

Referring to FIG. 1, there is shown a top perspective view of the motorcycle parking swing station ramp 10 assembled with the on off ramp 12 at the rear end of the rear wheel support member 14 is in its down position, the stop ramp 16 at the front end of the front wheel support member 18 in its up position, and a kick stand receiving plate 20 located on the left side of the motor cycle parking swing station ramp between the front and rear wheel support members. The rear and front wheel support members are each attached to square steel connecting members 22, 24 which are bolted together at their centers and are used to separate the front and rear wheel support members. The kick stand receiving plate projects out from the left side of the swing station ramp and is attached to connecting member 22.

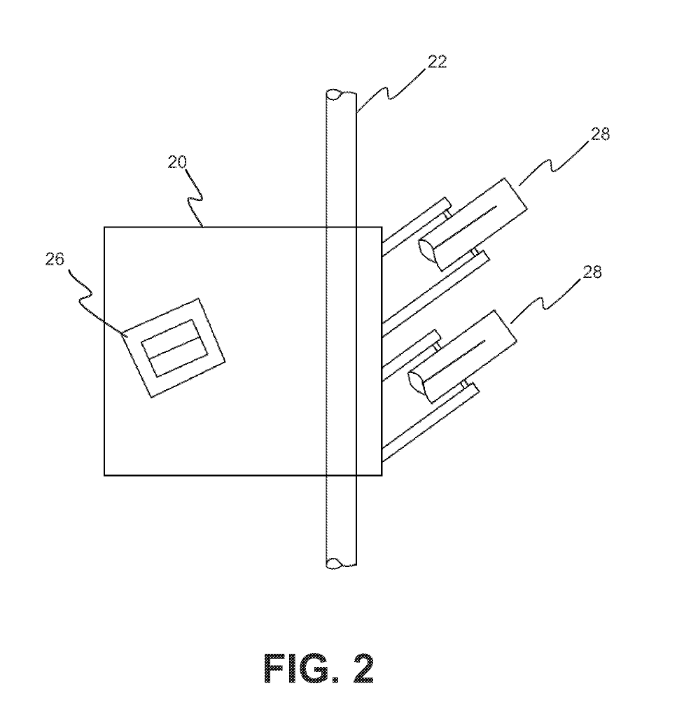

Looking at FIG. 2, there is shown a bottom perspective view of the kick stand receiving plate 20 showing three sets of wheels where each set has two wheels and the axel of each set of wheels is set at an angle which allows the wheels to rotate about an arc the center of which is located at the center of a rotatable plate which is located on the bottom of the front wheel support member. One set of wheels 26 is located at the left side of the kick stand receiving plate 20 and provides support for the left end of the plate. Two sets of double wheels 28 are located at the right side of the kick stand receiving plate and provide support for the right end of the plate. The kick stand receiving plate may be made of steel and is attached to the connecting member 22 with a set of bolts and nuts.

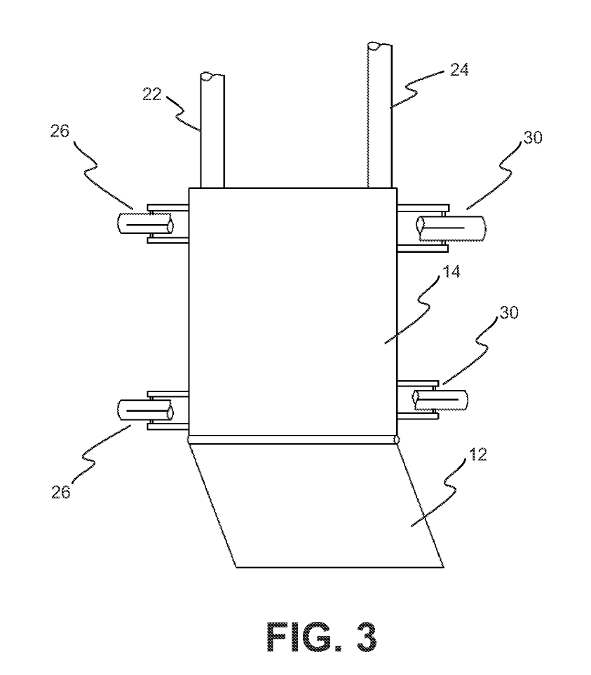

Looking at FIG. 3, there is shown a top perspective view of the motorcycle rear wheel support member 14 and on off ramp 12 at the end of the rear wheel support member in it's down position. The rear wheel support member has three sets of double wheels 30 where two sets are located near the rear of the rear wheel support member and one set of double wheels is located on the right side near the front of the rear wheel support member. A single wheel 32 is located on the left side near the rear of the front of the motorcycle rear wheel support member. The wheels are oriented to roll along a fixed arc, the center of which is located at the front wheel support member of the motorcycle front wheel support member. On off ramp 12 is pivotally coupled to the rear of the motorcycle rear wheel support member 14 and operates a locking mechanism which engages the rear wheels which prevents movement of the station ramp when the ramp is in its down position. The design of the locking mechanism is well known to a person having ordinary skill in the art. The ramp 12 which is attached to the rear wheel support member is hand operated and is moved to its down position when a motorcycle is to be rolled or driven onto the parking swing station ramp, and to its up position to prevent a motorcycle from rolling off the ramp. The wheel locking mechanism engages and prevents the rear wheel 30 from rotating when the on off ramp 12 is in its down position and does not prevent the rear wheels 30 from rotating when the on off ramp is in its up position.

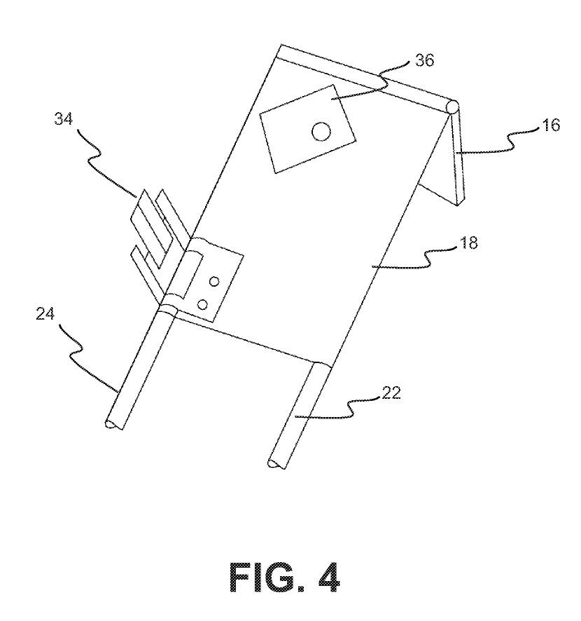

Referring to FIG. 4, there is shown a perspective view of the bottom of the motorcycle front wheel support member showing the rotatable support plate and a set of two wheels rotatably connected to a common axel. The set of wheels are oriented to travel along an arc shaped path the center of which is located at the center of the rotatable support plate located under the front wheel support member. The front wheel support member 18 is attached to the connecting members 22, 24 with bolts and nuts and the rotatable support plate 36 is rotatably attached to the front wheel support member with a single bolt. The rotatable support plate rests on the garage floor and is spaced from the front wheel support member with a nylon type of slip spacer which, together with the various wheels, allows the front wheel support member to be easily rotated when a motorcycle is located on the parking swing station ramp. Rotatably coupled to the front edge of the front wheel support member is the stop ramp which can be locked in it's up or down position.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A motorcycle parking swing station comprising:
a front wheel support member aligned with and attached to a rear wheel support member with connecting members;
a rotatable support plate located between the bottom of the front wheel support member and the ground;
a plurality of axles attached to the front and rear wheel support members; and
a plurality of support wheels rotationally attached to the plurality of axles;
wherein the wheels trace a circular path about the center of the rotatable support plate.

2. The motorcycle parking swing station of claim 1 wherein an on off access ramp is attached to the rear of the rear wheel support member,

3. The motorcycle parking swing station of claim 2 wherein an on off access ramp operated brake is adapted to engage wheels on the rear wheel support member to prevent movement of the swing station when the access ramp is positioned to receive or permit egress of a motorcycle.

4. The motorcycle parking swing station of claim 1 wherein a motorcycle wheel stop ramp is pivotally coupled to the front of the front wheel support member.

5. The motorcycle parking swing station of claim 4 wherein a wheel stop brake is attached to the wheel stop; wherein the wheel stop brake is adapted to engage the garage floor to prevent movement of the swing station when the wheel stop is positioned to prevent egress of a motorcycle or other vehicle from the front of the station.

6. The motorcycle parking swing station of claim 4 wherein a wheel lock is coupled to keep the wheel stop in its up or down position.

7. The motorcycle parking swing station of claim 1 wherein a nylon type slip spacer is located between the bottom of the front wheel support member and the top of the rotatable support plate.

8. The motorcycle parking swing station of claims 1 wherein a kick stand receiving plate is located between the front and rear wheel support members.
